(19) United States
(12) Patent Application Publication
(10) Pub. No.: US 2020/0374581 A1
(43) Pub. Date: Nov. 26, 2020

(54) KEY FOR ON-SCREEN TRANSMISSION

(71) Applicant: ELECTRICITE DE FRANCE, PARIS (FR)

(72) Inventor: Sandrine TONNOIR, SACLAY (FR)

(21) Appl. No.: 16/955,473

(22) PCT Filed: Dec. 12, 2018
(86) PCT No.: PCT/EP2018/084602

§ 371 Date: Jun. 18, 2020

(30) Foreign Application Priority Data
Dec. 19, 2017 (FR) 17 62484

(51) Int. Cl. H04N 21/436; H04N 21/418; H04N 21/41

(52) U.S. Cl. CPC H04N 21/436; H04N 21/4122; H04N 21/4183; H04N 21/4184

(57) ABSTRACT

Disclosed is a device for transmitting content over an external display facility, including: a processing unit; a USB connector; an HDMI connector; a data storage body; at least one wireless communication module; and an internal battery. The processing unit is designed, according to the mode, to: record visual content data on the data storage body when the data is received from the input connector and/or the at least one wireless communication module; encrypt the recorded data, or decrypt the encrypted data recorded on the data storage body; convert the content data into a media flow; and transmit the media flow via the output connector such that an external screen to which the device is connected transmits the corresponding media.

### BACKGROUND OF THE INVENTION

### Field of the Invention

The invention relates to the field of devices for transmitting visual and audiovisual content. US 2014/0156791 and US 2009/0141894 deal with this subject.

### Description of the Related Art

Multiple solutions allow content to be transmitted from a source device to a display device, for example from a computer to a screen. It is generally necessary for the output signal from the computer to be compatible with the screen, if necessary by the use of an additional adapter placed at the interface of the two devices.

For convenience, a wireless connection between the source device and the display device is preferred. For example, a user may wish to display visual content contained in a laptop computer on a fixed screen in a conference room without the need to physically link the two devices. Visual content is understood here to mean text, image, and/or video documents, optionally accompanied by audio content.

In practice, during the wireless transmission of content from the source device to the display device, any interruption or failure in the wireless connection, even temporary, could interrupt the transmission of the content. Display devices such as televisions and video projectors are generally not equipped with a buffer memory and associated software sufficient to maintain continuity of the transmission in the event of an interruption in the wireless connection. Systems such as the devices known by the brand name “Chromecast”, transmit content using a third-party wireless network (Wi-Fi). Such systems therefore have the abovementioned deficiencies. In addition, the use of a third-party wireless network to exchange content data poses security problems which remain an impediment to use in a business context, particularly when the user must use a wireless local area network for which the user cannot verify the security level. Finally, this type of system requires a continuous power source.

Other devices, such as the “Clickshare” products marketed by Barco, also require the use of a third-party wireless network. It is necessary to connect a transmitter part to a USB port of a source machine, whose operating system must necessarily be a version of “Windows” (Microsoft), as well as to install software components on the machine. The operation by transmitting a series of still images limits the quality of the rendering (generally by screenshot and at about 30 frames per second), not very suitable for playing videos.

Devices including an internal memory in which are stored the contents to be distributed are arranged to be physically connected to the display device. These devices may sometimes be controlled remotely, for example by means of a remote control via an infrared receiver. No data are transmitted wirelessly from such a device. Such devices are generally bulky and therefore not very suitable for portability. They must be powered by an external energy source (the power grid or via USB). In addition, such devices are provided essentially for distributing videos and not text documents or still images. As they generally have no operating system, updating the software components is impossible, which means compatibility with file formats not initially planned cannot be implemented. The data stored on such devices must be stored in legible form (unencrypted) so that they can be displayed and/or played whenever desired via a display device to which the device is connected. In the event of loss or theft of the device, the confidentiality of the data is compromised.

### SUMMARY OF THE DISCLOSURE

The invention improves the situation.

A device is proposed for the playing and/or displaying of content on an external display device and comprising:
a processing unit,
an input connector of the Universal Serial Bus (USB) type,
an output connector of the High Definition Multimedia Interface (HDMI) type,
a data storage member,
at least one wireless communication module, and
an internal battery.

The processing unit is arranged to implement a data acquisition mode and a mode of media stream transmission and of controlling said transmission.

The data acquisition mode comprises:
saving visual content data in the data storage member upon receiving such data from the input connector and/or the at least one wireless communication module, and
encrypting the saved data.

The media stream transmission mode comprises:
decrypting the encrypted data saved in the data storage member,
converting the content data into a media stream, and
transmitting said media stream via the output connector so that an external screen to which the device is connected plays and/or displays the corresponding media.

The internal battery is arranged to power the components of the device in transmission mode.

Such a device is self-sufficient in terms of energy and makes it possible to transmit visual content to a third-party display device via a video input, such as an HDMI port, without it being necessary for the content data to travel from a remote source device during the transmission. The transmission remains controllable by a remote device (not physically connected to the device). The content data are present on the storage member in an unencrypted state only during their playing and/or displaying and briefly upon receipt. The data are stored in encrypted form the rest of the time, including during the playing and/or displaying of other content. The on-the-fly encryption and decryption of the data can be made automatic, so that the data remain secure with no specific action by the user. The software components of the device can be updated, including the operating system, for example in order to extend the compatibility of the device to data formats not provided for during the design and manufacture of the device. The device is therefore upgradeable.

The following features may optionally be implemented. They may be implemented independently of one another or in combination with one another:
The device further comprises a biometric sensor. The processing unit is further arranged to implement an authentication step by means of the biometric sensor, the result of the authentication step determining whether to implement the step of decrypting the data saved in the device. The security of the stored data is thus improved, in particular in the event of loss or theft of the device.
The processing unit is further arranged to implement the transmission mode independently of any control device external to the device. A third-party device for control is thus unnecessary, which is particularly advantageous in a context of portable use.
The device further comprises an operation indicator. This makes it easy to identify, for example visually, the origin of a problem and/or the charge status of the integrated battery.
The device further comprises an electronic paper type of screen. A small, energy-efficient screen allows basic information to be displayed directly on the body of the key.
The data storage member comprises a memory dedicated to visual, audiovisual, and/or multimedia content data, or a memory portion dedicated to visual, audiovisual, and/or multimedia content data. The dedicated storage member thus makes it possible to facilitate the encryption of data as well as the updating of software. The device can also be used as a normal USB key, facilitating its use by users accustomed to such keys.

The processing unit is further arranged to allow a direct exchange of data between:
a Wi-Fi communication module of the device and a source device, and/or
a Wi-Fi communication module of the device and a control device.

This makes it possible to exchange data with the device, even when the device is not very accessible, for example plugged into a remote screen and during transmission.

According to another aspect, the applicant proposes a method for the playing and/or displaying of content on an external display device, comprising a first set of operations for data acquisition and a second set of operations for media stream transmission and for controlling said transmission, the two sets of operations being implemented by a same device.

The first set comprises:
saving visual content data in a data storage member upon receiving such data from an input connector and/or at least one wireless communication module, and
encrypting the saved data.

The second set comprises:
decrypting the encrypted data saved in the data storage member,
converting the content data into a media stream, and
transmitting said media stream via an output connector so that an external screen to which the connector is connected plays and/or displays the corresponding media.

According to another aspect, the applicant proposes a computer program comprising instructions for implementing a data acquisition mode and a mode of media stream transmission and of controlling said transmission, by a device as defined above, when this program is executed by a processor of said device.

The data acquisition mode comprises:
saving visual content data in the data storage member upon receiving such data from the input connector and/or the at least one wireless communication module, and
encrypting the saved data.

The media stream transmission mode comprises:
decrypting the encrypted data saved in the data storage member,
converting the content data into a media stream, and
transmitting said media stream via the output connector so that an external screen to which the device is connected plays and/or displays the corresponding media.

According to another aspect, the applicant proposes a non-transitory computer-readable storage medium on which a program as defined above is stored.

### BRIEF DESCRIPTION OF THE DRAWINGS

Other features, details, and advantages of the invention will be apparent from reading the detailed description below, and from an analysis of the appended drawings in which:

FIG. 1 shows a general view of a device according to the invention;

FIG. 2 shows a functional representation of components of the device of FIG. 1; and

FIG. 3 shows the cooperation of a device according to the invention with third-party devices.

The drawings and the following description essentially contain elements that are certain in nature. Therefore they can not only serve to provide a better understanding of the invention, but also to contribute to its definition where appropriate.

### DETAILED DESCRIPTION OF THE EMBODIMENTS

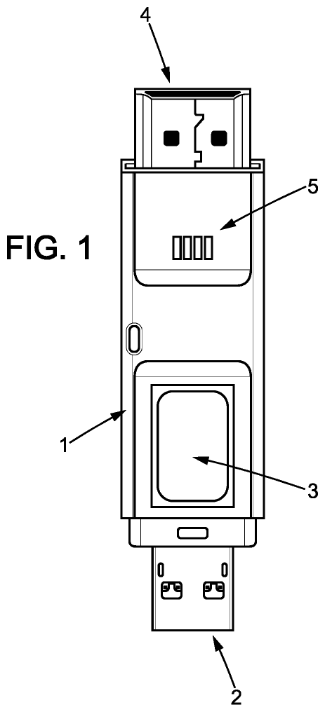

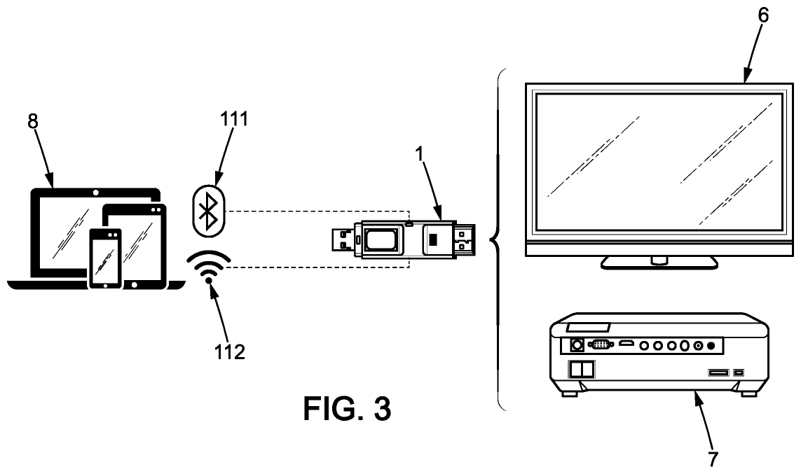

FIGS. 1 and 3 represent one embodiment of a device 1. The device 1 is arranged for the playing and/or displaying of content on an external display device, here for example an external screen 6 and/or a video projector 7, which are known per se. The display device has at least one input suitable for receiving an input stream, for example a video stream, such that the display device displays the visual content and, where appropriate, plays the associated audio content. The device may be arranged for playing content that is audiovisual, multimedia, or content of a single type, for example visual content only.

The device 1 has here a general “key” or “stick” shape, also called a “dongle”. In the example described here, the device 1 comprises:
a processing unit 130,
an input connector 2, here of the Universal Serial Bus (USB) type, for example a type A male connector,
an output connector 4, here of the High Definition Multimedia Interface (HDMI) type, for example an HDMI type A male connector,
a data storage member 143,
at least one wireless communication module 110, 111, 112, and
an internal battery 101.

The output connector 4 in the form of a type A male HDMI port enables mechanical compatibility with a large number of existing display devices without the need for an adapter. In addition, optional standards and protocols may be supported such as Display Data Channel (DDC) and/or Consumer Electronics Control (CEC). In some variants, the output connector 4 may be of another form compatible with transmission of a video stream, for example mini-HDMI (type C), micro-HDMI (type D), or may even be in compliance with standards other than HDMI, for example DisplayPort, Thunderbolt 1, USB 3.1, and combinations of such standards.

The input connector 2 in the form of a type A male USB port enables mechanical compatibility with a large number of existing source devices, in particular computers, without the need for an adapter. In the example described here, the input connector 2 is also used as a socket for recharging the internal battery 101. In some variants, the input connector 2 may be of another form, for example USB mini-AB or micro-AB, or may even be in compliance with standards other than USB.

The input connector 2 may alternatively be absent. In these cases, reception of content data by the device 1 from a third-party device can be ensured by means of at least one of the communication modules 110, 111, 112 and/or by means of an additional wireless communication module. In other words, at least one of the wireless communication modules 110, 111, 112 is used as a content data input interface of the device 1. In addition, other means that are known per se are used to enable recharging the internal battery 101, such as a dedicated port and/or magnetic resonance or an induction loop for wireless charging.

In some variants, the device 1 comprises a single USB port, alternately used as an input connector 2 and as an output connector 4 (and optionally as a socket for recharging the internal battery 101). In this case, the USB port is in compliance with recent standards for the transmission of a video stream, for example a type C connector and according to the USB 3.1 standard or a later standard.

The device 1 may be included in a kit further comprising one or more adapters making it possible to adapt the connectors 2 and 4 to various ports.

In the example shown in FIGS. 1 and 3, the device 1 further comprises a biometric sensor 3, here in the form of a fingerprint scanner, and an operation indicator 5, here a visual indicator in the form of a set of diodes making it possible to represent at least the charge level of the battery 101. In some variants, the device 1 comprises a screen, for example of the electronic paper type, which enables displaying parameters of the key.

The device 1 has at least two operating modes: a data acquisition mode and a mode of media stream transmission and of controlling said transmission.

In data acquisition mode, the output connector 4 is not used. Data can be exchanged between the device 1 and the source device to which it is connected, for example via the input connector 2 and/or by means of one of the wireless communication modules 110, 111, 112.

In transmission mode, the input connector 2 is not used. The device 1 receives external data for controlling the transmission, via one of the communication modules 110, 111, 112. Alternatively, no control data is received from outside the device during transmission. In this case, control is managed by the processing unit 130 according to preset parameters.

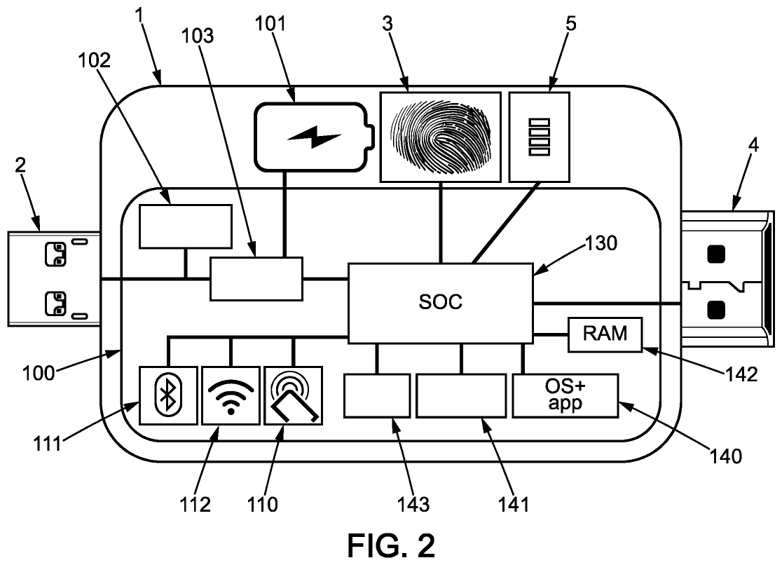

FIG. 2 schematically represents the functional elements of the device 1 and their interactions. FIG. 2 is not representative of the physical organization of the elements of the device 1. For example, two functional elements represented separately in FIG. 2 may be implemented by the same hardware component of the device 1.

The device 1 comprises an internal portion 100. The components of the device 1, for example the connectors 2, 4, the biometric sensor 3, the operation indicator 5, as well as the battery 101, are connected to the internal portion 100. The internal portion 100 is, for example, housed in a housing. The connectors 2, 4, the biometric sensor 3, and the operation indicator 5 are at least partially accessible from outside the housing of the device 1.

The internal portion 100 is arranged so as to provide an output signal via the output connector 4 as a function of visual content data stored in the data storage member 143, and optionally as a function of control data received via a communication module 110, 111, 112.

The internal portion 100 of the device 1 here comprises:
three wireless communication modules 110, 111, 112,
the processing unit 130,
the data storage member 143,
a control member 102 of the input connector 2 (USB here),
an energy management module 103,
an operating system 140,
a long-term storage flash memory 141, and
RAM working memory 142.

The internal portion 100 may be in the form of a circuit board receiving a set of components, in particular those mentioned above.

Here, distinction is made between the operating system 140, the data storage member 143 intended to receive content data to be displayed, and the flash memory 141 intended to store other types of data. In practice, these different types of data may be stored in non-transitory storage media that are similar to each other or may even be stored in the same medium. For example, a single memory can be partitioned so that the data relating to the operating system 140, the content data to be displayed, and the other data are stored separately. In this case, a partition can be viewed as a data storage member 143.

The processing unit 130 may also be called a controller. The processing unit 130 comprises at least one processor, for example in the form of a system on a chip or “SoC”. All electronic components of the device are connected to the processing unit, in particular the data storage member 143. The processing unit 130 controls and manages all the electronic components and executes the software functions of the device 1. As the device 1 is designed to be regularly connected to a source computer device, the software components of the device 1, including the operating system 140, can easily be updated, including wirelessly.

The communication modules 110, 111, 112 allow the device 1 to adapt to various environments. For example, certain categories of electromagnetic waves may be prohibited in specific environments. The plurality of communication modules makes it possible to adapt the communications means implemented by the device 1, as desired. In the example described here, the device 1 comprises:
a near-field communication module 110 (or NFC), meaning a range that is generally less than 10 centimeters,
a very short range communication module 111, meaning a range that is generally less than 20 meters, for example Bluetooth,
a short range communication module 112, meaning a range that is generally less than 100 meters, for example Wi-Fi.

Alternatively, a communication module compatible with a low power wireless network (or LPWan for “Low-Power Wide-Area Network”) is provided. Such communication, operating by relay, makes it possible to reach long distances.

The energy management module 103 is arranged to control the charging of the battery 101, here via the input connector 2. The energy management module 103 is arranged to supply power to the other components of the device 1, particularly in transmission mode.

The battery 101 and the energy management module 103 enable the device 1 to continue to operate independently of the availability of an external energy source, particularly in transmission mode. The device 1 can thus be arranged to be recharged by an external source, for example when temporarily plugged into the USB port of a computer.

The processing unit 130 is arranged to implement a data acquisition mode and a mode of media stream transmission and of controlling said transmission.

The data acquisition mode comprises:
saving visual content data in the data storage member upon receiving such data from the input connector and/or the at least one wireless communication module, and
encrypting the saved data.

During the saving process, the device 1 receives data, in particular visual content data to be displayed at a later time on a display device 6, 7.

In the examples described here, the data are encrypted upon receipt by the processing unit 130, then are stored permanently in encrypted form in the data storage member 143. For example, the legible data received (not encrypted) are temporarily stored upon receipt by means of the RAM working memory 142. Then, the legible data are deleted as soon as a corresponding encrypted version is stored in the data storage member 143. The use of the device 1 in data acquisition mode and from the point of view of the user is similar to that of a standard USB key. If the source device allows copying data to external media, for example via USB, then there is no need to install an additional software component on the source device enabling the use of the device 1 in data acquisition mode. The data transferred to the device 1 are automatically encrypted. The data are thus better protected in the event of loss or theft of the device 1.

The device 1 is arranged so that the user imports to it the data to be displayed, before the transmission, and preferably by a direct physical connection of the device 1 to his or her own source device, typically a computer. The data thus does not travel through a third-party network during transmission. However, the device 1 may be arranged so that it is also able to receive data from a remote (wireless) source device, for example by means of the wireless communication modules 110, 111, 112. Importing the content data from the source device to the device 1 can be done earlier in the process, prior to the transmission. Optionally, the import may be performed simultaneously with the transmission. In this case, a direct connection between the device 1 and the source device is preferred. Direct connection is understood here to mean in the absence of a third-party device such as a router. The source device is then arranged to transmit data to the device 1 independently of a third-party network, for example by itself generating a dedicated local area network, such as a Wi-Fi network, for example known under the name “Wi-Fi Direct”.

FIG. 3 represents a device 1 and its interactions with third-party devices in transmission mode.

The media stream transmission mode comprises:
decrypting the encrypted data saved in the data storage member,
converting the content data into a media stream,
transmitting said media stream via the output connector so that an external screen to which the device is connected plays and/or displays the corresponding media.

Thus, in transmission mode, a stream is continuously transmitted to a display device 6, 7 from the device 1 and via the output connector 4. The output signal, or stream, is taken from content data stored in the data storage member 143. The processing which converts the content data as stored into a signal capable of being played and/or displayed on the fly by the display device 6, 7 is obtained by computer processing/operations implemented by the processing unit 130 of the device 1.

Preferably, the decryption, conversion, and transmission are done on the fly. In other words, sections of a content being played and/or displayed are decrypted, converted, and then transmitted as soon as required and when necessary for their playing and/or displaying. The content is not stored in a legible version (unencrypted) in the device 1 for a significant period of time.

In the embodiment described here, the playing and/or displaying is controlled by a user from a control device 8, for example a remote third-party device. Such control includes, for example, the usual operations such as selecting the media to play, “play”, “pause”, volume control, etc. In the example described here, a tablet computer or a smart phone may be used interchangeably as the control device 8. The source device used in data acquisition mode can thus become the control device 8 in transmission mode. Alternatively, the control device 8 may comprise a remote control or any other control device.

In transmission mode, the data exchanged between the control device 8 and the device 1 may be command type data only and not contain any content data. The consequences on security if the exchanged data are intercepted during transmission are therefore little to none.

Such a device may be used in a professional context to facilitate collaboration between multiple people, in particular when it is desirable to use display devices without connecting a computer containing sensitive data to them.

Such devices may advantageously replace the local area networks and cables generally made available to intermittent users of a meeting room.

Depending on the intended uses, access to the data on the device 1 may be subject to prior identification of the user. For example, the NFC 110 and/or Bluetooth 111 module may be used to detect an identification badge. In the example described here, the biometric sensor 3 is connected to the processing unit 103 in order to implement user detection and identification. Access to data and/or initiation of the transmission mode may be subject to prior recognition of a legitimate user. The user identification and authentication are implemented here by means of a fingerprint scanner. As a variant, other biometric sensors are used in place of or as a complement to the fingerprint scanner.

The device 1 may further be used in transmission mode in the absence of an external energy source, for example connected only to the HDMI port of a screen.

The invention is not limited to the exemplary devices described above solely by way of example, but encompasses all the variants that a person skilled in the art can envisage within the scope of the protection sought.

1. A device for the playing and/or displaying of content on an external display device and comprising:
a processing unit,
an input connector of the Universal Serial Bus (USB) type,
an output connector of the High Definition Multimedia Interface (HDMI) type,
a data storage member,
at least one wireless communication module, and
an internal battery,
the processing unit being arranged to implement a data acquisition mode and a mode of media stream transmission and of controlling said transmission,
the data acquisition mode comprising:
saving visual content data in the data storage member upon receiving such data from the input connector and/or the at least one wireless communication module, and
encrypting the saved data,
the media stream transmission mode comprising:
decrypting the encrypted data saved in the data storage member,
converting the content data into a media stream, and
transmitting said media stream via the output connector so that an external screen to which the device is connected plays and/or displays the corresponding media,
the internal battery being arranged to power the components of the device in transmission mode.

2. The device according to claim 1, further comprising a biometric sensor, the processing unit being further arranged to implement an authentication step by means of the biometric sensor, the result of the authentication step determining whether to implement the step of decrypting the data saved in the device.

3. The device according to ene e claim 1, wherein the processing unit is further arranged to implement the transmission mode independently of any control device external to the device.

4. The device according to claim 1, further comprising an operation indicator.

5. The device according to claim 1, further comprising an electronic paper type of screen.

6. The device according to claim 1, wherein the data storage member comprises a memory dedicated to visual, audiovisual, and/or multimedia content data, or a memory portion dedicated to visual, audiovisual, and/or multimedia content data.

7. The device according to claim 1, wherein the processing unit is further arranged to allow a direct exchange of data between:
a Wi-Fi communication module of the device and a source device, and/or
a Wi-Fi communication module of the device and a control device.

8. A method for the playing and/or displaying of content on an external display device, comprising a first set of operations for data acquisition and a second set of operations for media stream transmission and for controlling said transmission, the two sets of operations being implemented by a same device,
the first set comprising:
saving visual content data in a data storage member upon receiving such data from an input connector and/or at least one wireless communication module, and
encrypting the saved data,
the second set comprising:
decrypting the encrypted data saved in the data storage member,
converting the content data into a media stream, and
transmitting said media stream via an output connector so that an external screen to which the connector is connected plays and/or displays the corresponding media.

9. A non-transitory computer-readable medium on which is stored a computer program comprising instructions for implementing a data acquisition mode and a mode of media stream transmission and of controlling said transmission, by a device according to claim 1 when this program is executed by a processor of said device, the data acquisition mode comprising:
saving visual content data in the data storage member upon receiving such data from the input connector and/or the at least one wireless communication module, and
encrypting the saved data,
the media stream transmission mode comprising:
decrypting the encrypted data saved in the data storage member,
converting the content data into a media stream, and
transmitting said media stream via the output connector so that an external screen to which the device is connected plays and/or displays the corresponding media.

10. (canceled)

11. A non-transitory computer-readable medium on which is stored a computer program comprising instructions for implementing a data acquisition mode and a mode of media stream transmission and of controlling said transmission, by a device according to claim 2 when this program is executed by a processor of said device,
the data acquisition mode comprising:
saving visual content data in the data storage member upon receiving such data from the input connector and/or the at least one wireless communication module, and
encrypting the saved data,
the media stream transmission mode comprising:
decrypting the encrypted data saved in the data storage member,
converting the content data into a media stream, and
transmitting said media stream via the output connector so that an external screen to which the device is connected plays and/or displays the corresponding media.

12. A non-transitory computer-readable medium on which is stored a computer program comprising instructions for implementing a data acquisition mode and a mode of media stream transmission and of controlling said transmission, by a device according to claim 3 when this program is executed by a processor of said device,
the data acquisition mode comprising:
saving visual content data in the data storage member upon receiving such data from the input connector and/or the at least one wireless communication module, and
encrypting the saved data,
the media stream transmission mode comprising:
decrypting the encrypted data saved in the data storage member,
converting the content data into a media stream, and
transmitting said media stream via the output connector so that an external screen to which the device is connected plays and/or displays the corresponding media.

13. A non-transitory computer-readable medium on which is stored a computer program comprising instructions for implementing a data acquisition mode and a mode of media stream transmission and of controlling said transmission, by a device according to claim 4 when this program is executed by a processor of said device,
the data acquisition mode comprising:
saving visual content data in the data storage member upon receiving such data from the input connector and/or the at least one wireless communication module, and
encrypting the saved data,
the media stream transmission mode comprising:
decrypting the encrypted data saved in the data storage member,
converting the content data into a media stream, and
transmitting said media stream via the output connector so that an external screen to which the device is connected plays and/or displays the corresponding media.

14. A non-transitory computer-readable medium on which is stored a computer program comprising instructions for implementing a data acquisition mode and a mode of media stream transmission and of controlling said transmission, by a device according to claim 5 when this program is executed by a processor of said device,
the data acquisition mode comprising:
saving visual content data in the data storage member upon receiving such data from the input connector and/or the at least one wireless communication module, and
encrypting the saved data,
the media stream transmission mode comprising:
decrypting the encrypted data saved in the data storage member,
converting the content data into a media stream, and
transmitting said media stream via the output connector so that an external screen to which the device is connected plays and/or displays the corresponding media.

15. A non-transitory computer-readable medium on which is stored a computer program comprising instructions for implementing a data acquisition mode and a mode of media stream transmission and of controlling said transmission, by a device according to claim 6 when this program is executed by a processor of said device,
the data acquisition mode comprising:
saving visual content data in the data storage member upon receiving such data from the input connector and/or the at least one wireless communication module, and
encrypting the saved data,
the media stream transmission mode comprising:
decrypting the encrypted data saved in the data storage member,
converting the content data into a media stream, and
transmitting said media stream via the output connector so that an external screen to which the device is connected plays and/or displays the corresponding media.

16. A non-transitory computer-readable medium on which is stored a computer program comprising instructions for implementing a data acquisition mode and a mode of media stream transmission and of controlling said transmission, by a device according to claim 7 when this program is executed by a processor of said device,
the data acquisition mode comprising:
saving visual content data in the data storage member upon receiving such data from the input connector and/or the at least one wireless communication module, and
encrypting the saved data,
the media stream transmission mode comprising:
decrypting the encrypted data saved in the data storage member,
converting the content data into a media stream, and
transmitting said media stream via the output connector so that an external screen to which the device is connected plays and/or displays the corresponding media.

17. The device according to claim 2, wherein the processing unit is further arranged to implement the transmission mode independently of any control device external to the device.

18. The device according to claim 2, further comprising an operation indicator.

19. The device according to claim 3, further comprising an operation indicator.

20. The device according to claim 2, further comprising an electronic paper type of screen.

21. The device according to claim 3, further comprising an electronic paper type of screen.
